(19) United States
(12) Patent Application Publication
(10) Pub. No.: US 2014/0361564 A1
(43) Pub. Date: Dec. 11, 2014

(54) Hook-Pulley Combination

(71) Applicant: Chin-Shun Huang, Taichung City (TW)

(72) Inventor: Chin-Shun Huang, Taichung City (TW)

(21) Appl. No.: 13/910,843

(22) Filed: Jun. 5, 2013

(51) Int. Cl. B66D 3/04; F16B 45/02

(52) U.S. Cl. CPC B66D 3/04; F16B 45/02
USPC 294/82.11; 24/601.5

(57) ABSTRACT

A hook-pulley combination includes a hook, a latch and a pulley assembly. The hook includes an intermediate portion extending between two arched portions. The first arched portion is formed with two supporting portions. There is a gap between an end of the first arched portion and an end of the second arched portion. The latch includes an end pivotally connected to the end of the first arched portion and another end for engagement with the end of the second arched portion to close the gap. The pulley assembly includes an axle supported on the supporting portions and a pulley supported on the axle.

### BACKGROUND OF INVENTION

1. Field of Invention

The present invention relates to a life-saving appliance and mountaineering equipment and, more particularly, to a hook-pulley combination.

2. Related Prior Art

Referring to FIG. 1, there is shown a conventional hook-pulley combination for use as a life-saving appliance or mountaineering equipment. The hook-pulley combination includes a hook 10 and a pulley assembly 20. The hook 10 includes an intermediate portion 11 extending between two arched portions 12 and 13. There is a gap 15 between an end 18 of the first arched portion 12 and an end 19 of the second arched portion 13. A latch 14 includes an end pivotally connected to the end 18 and another end formed with a dovetail groove 16. A dovetail 17 is formed at the end 19. The pulley assembly 20 includes a pulley 24 supported on an axle 23 that is supported on two supporting elements 21 each of which includes an aperture 22 for receiving the first arched portion 12. A clip 25 is engaged with each end of the axle 23 that extends beyond a corresponding one of the supporting elements 21. The pulley 24 is kept on the axle 23, which is kept on the supporting elements 21 by the clips 25. In use, a rope is wound around the pulley 24. The dovetail 17 is moved out of the dovetail groove 16, i.e., the gap 15 is opened to allow engagement of the second arched portion 13 of the hook 10 with an external object. Finally, the dovetail 17 is returned into the dovetail groove 16, i.e., the gap 15 is closed again. The use of the hook-pulley combination is not without any problem. For example, the supporting elements 21 and the first arched portion 12 of the hook 10 inevitably wear and tear each other. Moreover, the supporting elements 21 would undesirably be pivoted relative to the hook 10.

Therefore, the present invention is intended to obviate or at least alleviate the problems encountered in prior art.

### SUMMARY OF INVENTION

It is the primary objective of the present invention to provide a robust and reliable hook-pulley combination.

To achieve the foregoing objective, the hook-pulley combination includes a hook, a latch and a pulley assembly. The hook includes is an intermediate portion extending between two arched portions. The first arched portion includes two supporting portions. There is a gap between an end of the first arched portion and an end of the second arched portion. The latch includes an end pivotally connected to the end of the first arched portion and another end for engagement with the end of the second arched portion to close the gap. The pulley assembly includes an axle supported on the supporting portions and a pulley supported on the axle.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of a conventional hook-pulley combination;

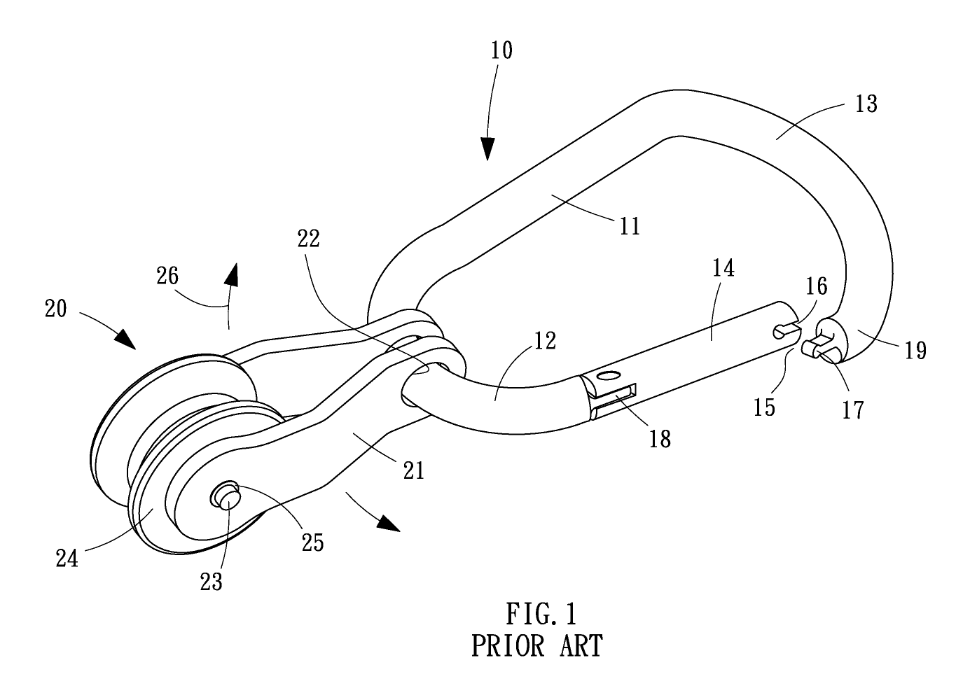

FIG. 2 is an exploded view of a hook-pulley combination according to the preferred embodiment of the present invention;

FIG. 3 is a perspective view of the hook-pulley combination in another position than shown in FIG. 2; and

FIG. 4 is a partially cross-sectional view of the hook-pulley combination shown in FIG. 3.

### DETAILED DESCRIPTION OF PREFERRED EMBODIMENT

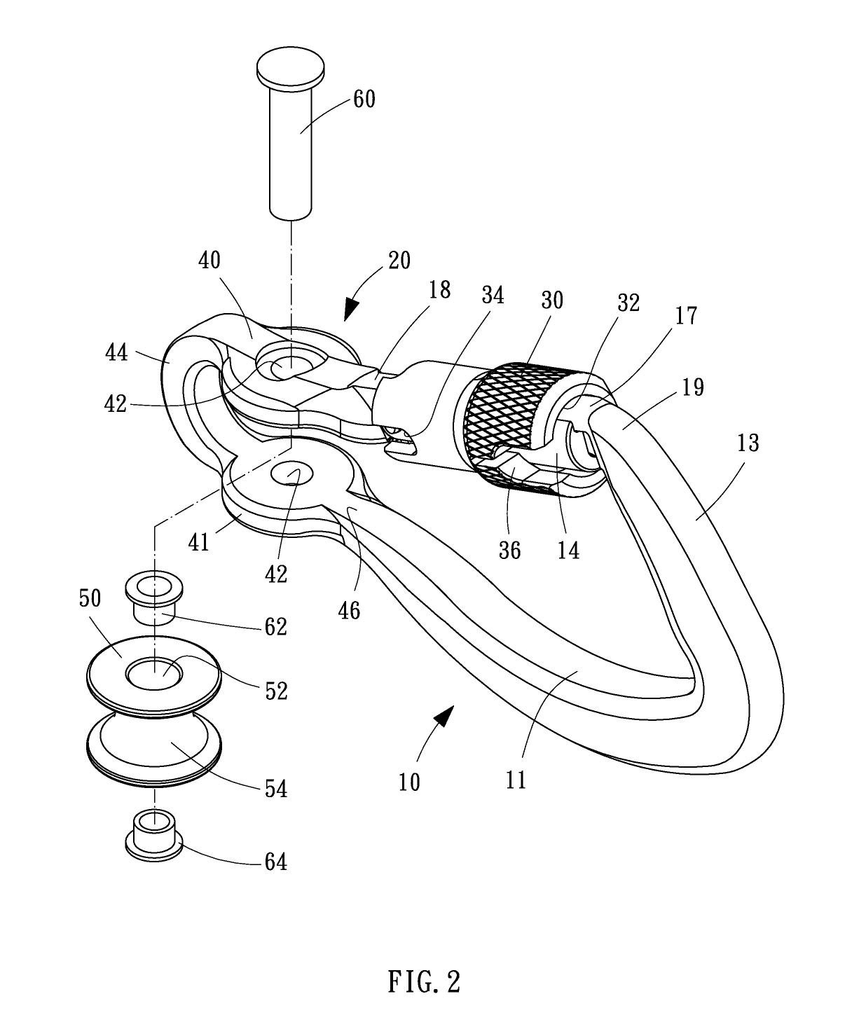

Referring to FIGS. 2 through 4, there is shown a hook-pulley combination according to the preferred embodiment of the present invention. The hook-pulley combination includes a hook 10 and a pulley assembly 20. The hook 10 includes an intermediate portion 11 extending between two arched portions 44 and 13. There is a gap between an end 18 of the first arched portion 44 and an end 19 of the second arched portion 13 like the gap 15 described in the Related Prior Art.

The gap 15 is closed or opened by a latch 14 that includes an end pivotally connected to the end 18 and another end formed with a dovetail groove like the dovetail 17 described in the Related Prior Art. The end 19 is formed with a dovetail like the dovetail 17 described in the Related Prior Art.

A locking collar 30 is rotationally placed around the latch 14. The locking collar 30 includes a space 32 with two open ends, two opposite slits 34 near the first open end of the space 32, and two opposite slits 36 near another open end of the space 32. The width of the slits 34 is larger than that of the end 18. The width of the slits 36 is larger than that of the dovetail 17.

The first arched portion 44 includes two supporting portions 40, one placed near the intermediate portion 11, the other placed near the end 18. Each of the supporting portions 40 is preferably a disc with a countersink hole 42.

The pulley assembly 20 includes a pulley 50 supported on two bushings 62 that are supported on an axle 60 that is supported on the supporting portions 40. The pulley 50 includes a tunnel 52 and an annular concave face 54.

The bushings 62 are preferably made of a material softer than metal of which the hook 10 is made. Each of the bushings 62 includes an annular flange 64 extending around an end. Each of the bushings 62 is inserted in a corresponding open end of the tunnel 52 while the annular flange 64 is placed out of the tunnel 52. The annular flange 64 of each of the bushings 62 is placed between a corresponding one of the supporting portions 40 and a corresponding end of the pulley 50.

The axle 60 is inserted in the tunnel 52 and the countersink holes 42. The axle 60 is preferably a rivet with two enlarged end placed in the countersink holes 42. The pulley 50 is kept on the axle 60, which is kept on the supporting portions 40 by the enlarged ends.

The diameter of the supporting portions 40 is preferably larger than that of the pulley 50 so that the supporting portions 40 protect the pulley 50. However, the diameter of the supporting portions 40 may be identical to or smaller than that of the pulley 50.

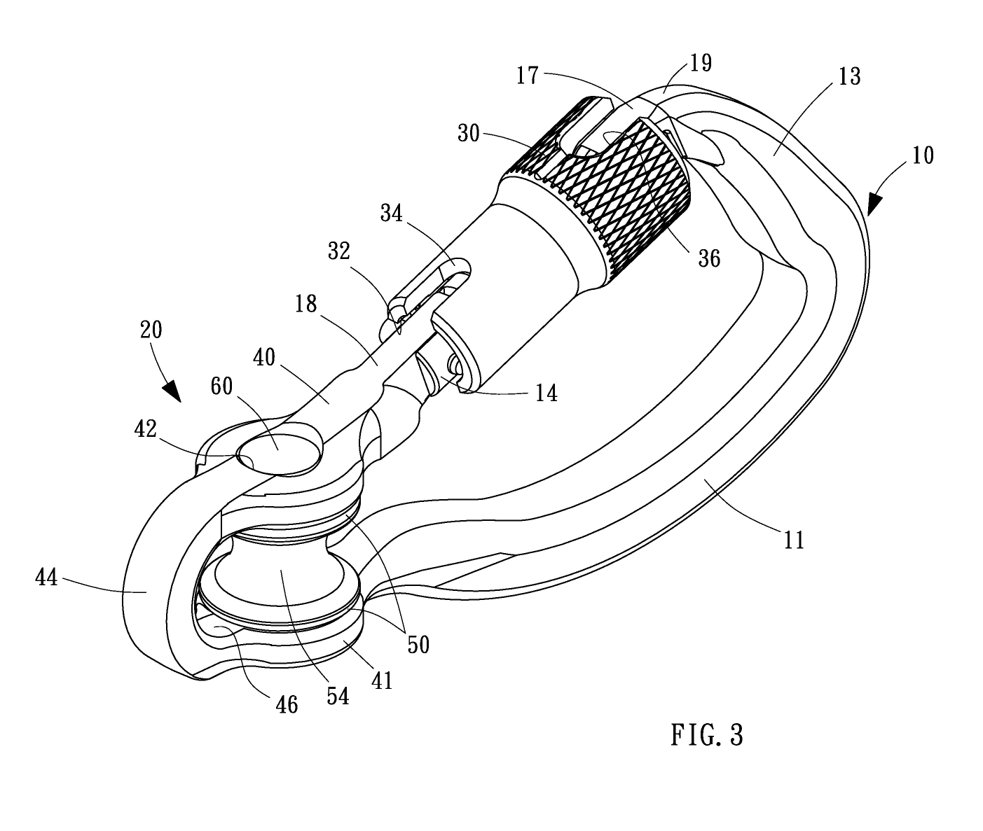

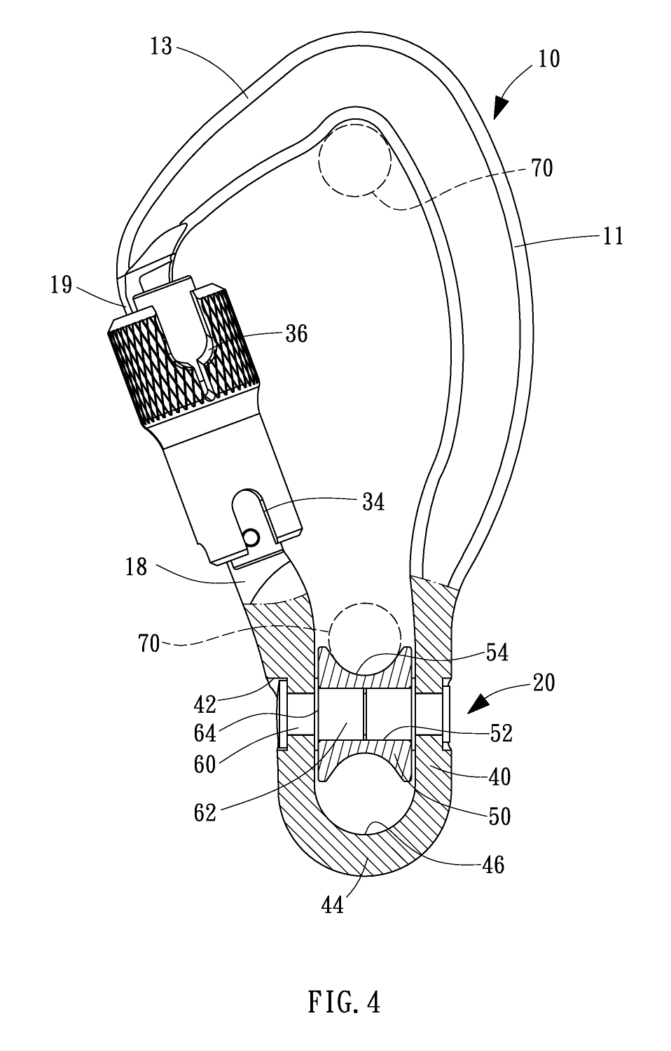

In use, a rope 70 is wound around the pulley 50 and, more particularly, in contact with the annular concave face 54 as shown in FIG. 4. The locking collar 30 is placed in a releasing position where the slits 34 are aligned with the end 18 and the slits 36 are aligned with the dovetail 17 as shown in FIG. 3 to allow movement of the dovetail 17 out of the dovetail groove 16, i.e., the gap 15 is opened to allow engagement of the second arched portion 13 of the hook 10 with an external object. The dovetail 17 is returned into the dovetail groove 16, i.e., the gap 15 is closed again. Finally, the locking collar 30 is rotated to a locking position where the slits 34 are not aligned with the end 18 and the slits 36 are not aligned with the dovetail 17 as shown in FIG. 2 to prevent movement of the dovetail 17 out of the dovetail groove 16.

Advantageously, the hook-pulley combination of the present invention does not include anything like the supporting elements 21 described in the Related Prior Art that inevitably wear the hook 10. Moreover, the hook-pulley combination of the present invention does not include anything like the supporting elements 21 described in the Related Prior Art that would pivot relative to the hook 10.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A hook-pulley combination including:
a hook including a first arched portion formed with two supporting portions and an end near one of the supporting portions, a second arched portion formed with an end, an intermediate portion extending between the first and second arched portions and a gap between the ends of the first and second arched portions;
a latch including an end pivotally connected to the end of the first arched portion and another end for engagement with the end of the second arched portion to close the gap; and
a pulley assembly including an axle supported on the supporting portions and a pulley supported on the axle.

2. The hook-pulley combination according to claim 1, wherein the pulley assembly includes two bushings for supporting the pulley on the axle.

3. The hook-pulley combination according to claim 2, wherein each of the bushings includes an annular flange placed between a corresponding one of the supporting portions and a corresponding end of the pulley.

4. The hook-pulley combination according to claim 1, wherein the supporting portions are discs.

5. The hook-pulley combination according to claim 4, wherein the discs are made with a diameter larger than that of the pulley.

6. The hook-pulley combination according to claim 1, wherein the axle is a rivet, wherein each of the supporting portions includes a countersink hole for receiving a corresponding enlarged end of the rivet.
